(19) United States
(12) Patent Application Publication
(10) Pub. No.: US 2023/0363581 A1
(43) Pub. Date: Nov. 16, 2023

(54) SERVER AND METHOD FOR CONTROLLING SAME

(71) Applicant: SAMSUNG ELECTRONICS CO., LTD., Suwon-si (KR)

(72) Inventors: Sanga KIM, Suwon-si (KR); Yunkyeong LEE, Suwon-si (KR); Juneok AHN, Suwon-si (KR)

(73) Assignee: SAMSUNG ELECTRONICS CO., LTD., Suwon-si (KR)

(21) Appl. No.: 18/226,666

(22) Filed: Jul. 26, 2023

Related U.S. Application Data
(63) Continuation of application No. PCT/KR2022/004124, filed on Mar. 24, 2022.

(30) Foreign Application Priority Data
Apr. 8, 2021 (KR) 10-2021-0045803

(51) Int. Cl. A47J 36/32; A47L 15/00; A23L 3/365; F24C 15/00

(52) U.S. Cl. CPC A47J 36/321; A47L 15/0063; A23L 3/365; F24C 15/00

(57) ABSTRACT

A server includes: a transceiver configured to perform communication with a user terminal and a cooking device; and a processor operatively connected to the transceiver, wherein the processor is configured to: based on receiving a selection of a recipe from the user terminal, control the transceiver to transmit, to the user terminal, recipe guide information corresponding to the recipe, and transmit, to the cooking device, control information corresponding to the recipe, wherein the recipe includes a defrosting step and a cooking step, which use the cooking device.

### CROSS-REFERENCE TO RELATED APPLICATIONS

This application is a by-pass continuation application of International Application No. PCT/KR2022/004124, filed on Mar. 24, 2022, which is based on and claims priority to Korean Patent Application No. 10-2021-0045803, filed on Apr. 8, 2021, in the Korean Intellectual Property Office, the disclosures of which are incorporated by reference herein their entireties.

### BACKGROUND

### 1. Field

The disclosure relates to a server and a method for controlling the same capable of controlling a cooking device at home.

### 2. Description of Related Art

Cooking devices are configured to cook foods by heating cooking object, and to provide various functions related to cooking, such as heating, thawing, drying, and sterilizing of an object or objects to be cooked.

For example, the cooking devices may include an oven that cooks a cooking object by transferring heat directly to the object or heating the inside of the cooking chamber through a thermal source, e.g., a heater, which generates heat, and a microwave that cooks the cooking object with intermolecular frictional heat produced by a high frequency from a thermal source, a magnetron, disturbing molecular arrangement of the cooking object.

Technologies by which the cooking device receives recipe information by communicating with an external device and performs cooking based on the recipe information have been studied these days.

### SUMMARY

Provided are a method and a server that determines a recipe including defrosting and cooking steps by using a cooking device and that controls the cooking device based on the recipe.

According to an aspect of the disclosure, a server includes: a transceiver configured to perform communication with a user terminal and a cooking device; and a processor operatively connected to the transceiver, wherein the processor is configured to: based on receiving a selection of a recipe from the user terminal, control the transceiver to transmit, to the user terminal, recipe guide information corresponding to the recipe, and transmit, to the cooking device, control information corresponding to the recipe, wherein the recipe includes a defrosting step and a cooking step, which use the cooking device.

The processor may be further configured to: determine at least one recipe based on the cooking device, a cooking object that is available, and a user-selected recipe name, and control the transceiver to transmit information about the at least one recipe to the user terminal.

The processor may be further configured to: search for a recipe corresponding to the user-selected recipe name and being available with the cooking device and the cooking object, and, based on the searched recipe including a defrosting step without using the cooking device, determine a recipe by changing the defrosting step of the searched recipe to a defrosting step using the cooking device.

The processor may be further configured to determine the control information for the cooking device by determining a defrosting time and a defrosting temperature based on information about the cooking object.

The at least one recipe may include a recipe with a shortest cooking time, a recipe focused on taste, and a recipe focused on a condition of the cooking object.

The cooking device may include a plurality of cooking devices, and wherein the processor may be further configured to control the transceiver to transmit the control information to at least one of the plurality of cooking devices.

The processor may be further configured to determine a cooking device to perform the defrosting step of the recipe among the plurality of cooking devices, based on at least one of a type of the recipe or a type of the cooking object.

The recipe guide information may include information about an operation order between the plurality of cooking devices and information about a user action.

The control information may include at least one of information about an operation time of the cooking device or information about an operation temperature of the cooking device.

The processor may be further configured to control the transceiver to transmit, to a dish washer, a washing mode based on the selected recipe.

According to another aspect of the disclosure, a method of controlling a server including a transceiver for performing communication with a user terminal and a cooking device, includes: based on a selection of a recipe, which is received from the user terminal, controlling the transceiver to transmit, to the user terminal, recipe guide information corresponding to the recipe; and controlling the transceiver to transmit control information corresponding to the recipe to the cooking device, wherein the recipe includes a defrosting step and a cooking step, which use the cooking device.

The method may further include: determining at least one recipe based on the cooking device, a cooking object that is available, and a user-selected recipe name; and controlling the transceiver to transmit information about the at least one recipe to the user terminal.

The determining of the at least one recipe may include: searching for a recipe corresponding to the user-selected recipe name and being available with the cooking device and the cooking object; and determining, based on the searched recipe including a defrosting step without using the cooking device, the at least one recipe by changing the defrosting step of the searched recipe to a defrosting step using the cooking device.

The method may further include: determining the control information for the cooking device by determining a defrosting time and a defrosting temperature based on information about the cooking object.

The at least one recipe may include a recipe with a shortest cooking time, a recipe focused on taste, and a recipe focused on a condition of the cooking object.

According to one or more embodiments, a server provides the user a recipe that may shorten defrosting time and provides a defrosting step and a cooking step in one recipe by determining the recipe including the defrosting and cooking steps using a cooking device and controlling the cooking device based on the recipe, thereby helping to perform efficient cooking.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a cooking device control system, according to an embodiment;

FIG. 2 is a control block diagram of a server, according to an embodiment;

FIG. 3 is a signal sequence chart of a server determining a recipe, according to an embodiment;

FIG. 4 is a diagram illustrating an occasion when a user terminal displays recipe names, according to an embodiment;

FIG. 5 is diagram illustrating configuration of a recipe, according to an embodiment;

FIG. 6 is a diagram for describing an occasion when a user terminal displays recipes corresponding to a selected recipe name, according to an embodiment;

FIG. 7 is a signal sequence chart of a server performing cooking with a selected recipe, according to an embodiment;

FIG. 8 is a diagram illustrating operations of a cooking device and corresponding user actions, according to an embodiment;

FIG. 9 is a flowchart of controlling a cooking device in a method of controlling a server, according to an embodiment; and

FIG. 10 is a flowchart of determining a recipe including a defrosting step using a cooking device in a method of controlling a server, according to an embodiment.

### DETAILED DESCRIPTION

Embodiments and features as described and illustrated in the disclosure are merely examples, and there may be various modifications replacing the embodiments and drawings at the time of filing this application.

It will be further understood that the term “connect” or its derivatives refer both to direct and indirect connection, and the indirect connection includes a connection over a wireless communication network.

The terminology used herein is for the purpose of describing particular embodiments only and is not intended to limit the disclosure. It is to be understood that the singular forms “a,” “an,” and “the” include plural references unless the context clearly dictates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are only for the purpose of distinguishing a component from another. Thus, a first element, component, region, layer or room discussed below could be termed a second element, component, region, layer or section without departing from the teachings of the disclosure.

Furthermore, the terms, such as “— part”, “— block”, “— member”, “— module”, etc., may refer to a unit of handling at least one function or operation. For example, the terms may refer to at least one process handled by hardware such as field-programmable gate array (FPGA)/application specific integrated circuit (ASIC), etc., software stored in a memory, or at least one processor.

Reference numerals used for method steps are just used to identify the respective steps, but not to limit an order of the steps. Thus, unless the context clearly dictates otherwise, the written order may also be practiced otherwise.

Reference will now be made in detail to embodiments of the disclosure, which are illustrated in the accompanying drawings.

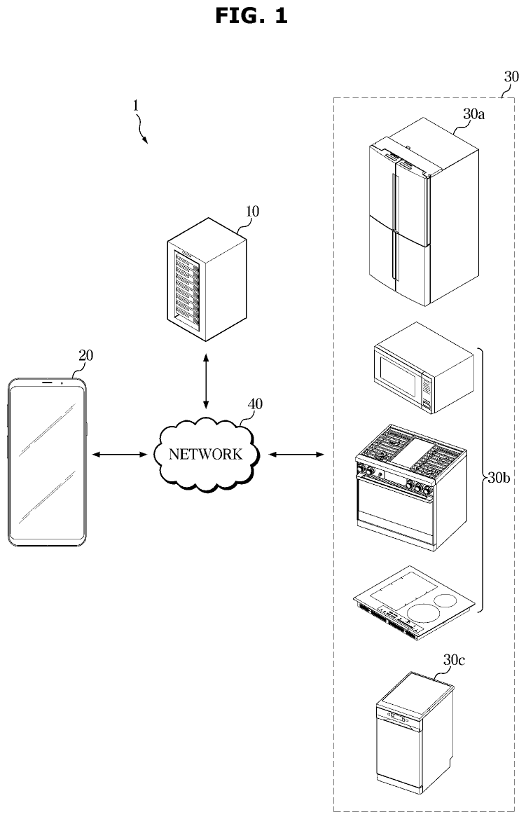

FIG. 1 illustrates a cooking device control system, according to an embodiment.

Referring to FIG. 1, a cooking device control system 1 includes a server 10, a user terminal 20, home appliances 30, and a network 40.

In an embodiment, the server 10 may communicate with the user terminal 20 and the home appliances 30 over the network 40, determine a recipe based on a user input through the user terminal 20, and control the home appliances 30 based on the recipe.

The ‘recipe’ may refer to how to cook a cooking object, and the cooking object is an object to be cooked by a cooking device 30b and may correspond to food ingredients that make up a food or frozen food.

In one or more embodiments, the server 10 may determine the recipe to include a defrosting step and a cooking step, which use the cooking device 30b of the home appliances 30.

In one or more embodiments, by determining the recipe to include the defrosting step that uses the cooking device 30b, the server 10 may increase cooking efficiency because the cooking object is thawed more quickly.

Furthermore, in one or more embodiments, the server 10 may increase cooking convenience of the user by integrating the defrosting step and the cooking step into one recipe, as compared to an occasion when the defrosting step and the cooking step are provided in separate recipes.

In one or more embodiments, the server 10 may transmit control information to each cooking device 30b based on the determined recipe, for the cooking device 30b to automatically set a cooking setting value.

Furthermore, in one or more embodiments, the server 10 transmits recipe guide information to the user terminal 20 based on the determined recipe, for the user terminal 20 to indicate the user actions corresponding to the recipe.

As such, the server 10 controls the cooking device 30b to have the cooking object defrosted and cooked sequentially based on the determined recipe, and indicates the user actions through the user terminal 20 to complete cooking of the cooking object.

In an embodiment, the user terminal 20 may include a user interface to display information for the user or receive a user input, and may correspond to a user equipment such as a smart phone.

In an embodiment, the user terminal 20 may communicate with the server 10 and the home appliances 30 through a radio communication protocol known to the public. Types of the user terminal 20 are not limited thereto, and may be provided as a well-known user terminal including a communication module and a user interface.

The user terminal 20 may display a plurality of recipe names based on information about an available cooking object, which is received from a refrigerator 30a of the home appliances 30 or information about the cooking object, which is obtained using a camera of the user terminal 20, and may receive a user input for one of the plurality of recipe names.

In this case, the recipe names may refer to or correspond to names of foods to be cooked with recipes, and may correspond to, for example, a stake recipe, a baking recipe, a pasta recipe, a salad recipe, etc.

The user terminal 20 may transmit a selected recipe name to the server 10, and may receive, from the server 10, information about at least one recipe corresponding to the selected recipe name. The user may select one of the at least one recipe to perform cooking with the recipe.

In this case, the user terminal 20 may display a message guiding the user to a recipe based on the recipe guide information received from the server 10. Accordingly, the user may perform an action for cooking, and with the user action and operation of the cooking device 30b, cooking of the cooking object may be performed.

In an embodiment, the home appliances 30 may be electronic devices installed at home, and may include the refrigerator 30a, the cooking device 30b and a dish washer 30c.

In an embodiment, the refrigerator 30a may be a home appliance for keeping cooking objects refrigerated or frozen, and may include a storage chamber for storing the cooking objects.

In this case, the refrigerator 30a may include a camera equipped in the storage chamber to identify the cooking object stored in the storage chamber by performing image processing on an image of the storage chamber captured by the camera and may generate information about the cooking object based on the identified cooking object. The information about the cooking object is information about cooking objects available to the user, i.e., cooking objects stored in the refrigerator 30a, which may include a list of cooking objects, types of the cooking objects, weight of the cooking objects, etc.

Furthermore, in some embodiments, the refrigerator 30a may include a weight sensor in the freezer to identify weight of the cooking objects, and include an input device to receive information about a cooking object from the user.

The refrigerator 30a may deliver the information about the cooking object to the server 10 or the user terminal 20, and update the list of cooking objects after completion of cooking.

In an embodiment, the cooking device 30b corresponds to a home appliance including a thermal source to cook the cooking object.

The cooking device 30b corresponds to a cooking device owned by the user and may be provided in at least one.

For example, the cooking device 30b may include a microwave (that cooks the cooking object with intermolecular frictional heat produced from disturbance of molecular arrangement of the cooking object by a high frequency), an oven (that cooks the cooking object by transferring heat directly to the cooking object or heating the inside of the cooking chamber with a thermal source for producing heat, such as a heater), and an induction range (that cooks the cooking object with a thermal source such as an inductive heating coil_.

Types of the cooking device 30b are not, however, limited thereto, and may include well-known types of cooking device such as an immersion circulator, a probe, etc.

In an embodiment, the cooking device 30b may perform cooking based on control information received from the server 10. Specifically, the cooking device 30b may perform cooking by controlling the thermal source based on operation time information and operation temperature information in the control information.

In an embodiment, the dish washer 30c corresponds to a home appliance for cleaning dishes by jetting water to dishes received in the washing tub.

When cooking is finished in the cooking device 30b, the dish washer 30c may receive, from the server 10, cleaning mode information corresponding to the recipe performed, and may perform a cleaning process according to the cleaning mode information.

In an embodiment, the network 40 may include at least one of telecommunication networks, e.g., computer networks (e.g., local area network (LAN) or wide area networks (WAN)), the Internet, or telephone networks.

In an embodiment, each of the server 10, the user terminal 20 and the home appliances 30 may be wiredly or wirelessly connected to the network 40 to transmit or receive information to or from one another. Alternatively, the user terminal 20 and the home appliances 30 may be directly connected to each other to communicate with each other without going through the network 40.

The cooking device control system 1 has thus far been briefly described. How the server 10 determines a recipe and sequentially controls the cooking device 30b based on the recipe will now be described in detail.

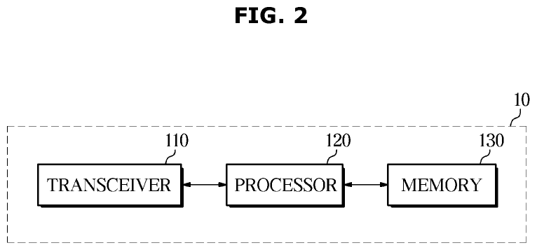

FIG. 2 is a control block diagram of the server 10, according to an embodiment.

Referring to FIG. 2, the server 10 according to an embodiment includes a transceiver 110 for communicating with an external electronic device, a processor 120 for determining a recipe and controlling the user terminal 20 and the cooking device 30b to perform cooking with the recipe, and a memory 130 for storing various information required for control.

In an embodiment, the transceiver 110 may transmit or receive information to or from the user terminal 20 and the home appliances 30 over the network 40. For this, the transceiver 110 may include a wired communication module of a well-known type or a wireless communication module of a well-known type.

In an embodiment, the processor 120 may determine a recipe to be performed.

Specifically, the processor 120 may determine at least one recipe corresponding to a recipe name when the recipe name is an input from the user and transmit the at least one recipe to the user terminal 20, and based on reception of a selection of a recipe from the user terminal 20, determine the selected recipe as a recipe to be performed.

In this case, the processor 120 may control the transceiver 110 to transmit, to the user terminal 20, recipe guide information corresponding to the recipe to be performed and transmit, to the cooking device 30b, control information corresponding to the recipe to be performed.

The user terminal 20 may display a message for guiding a recipe based on the recipe guide information, the user may perform an action of placing the cooking object into the cooking device 30b according to the message displayed on the user terminal 20, and the cooking device 30b may perform cooking based on the control information received from the server 10.

In this case, the processor 120 may determine a recipe including a defrosting step and a cooking step. Specifically, the recipe may include a defrosting step for unfreezing the cooking object and a cooking step for cooking the cooking object by heating.

The defrosting step and the cooking step may be performed by the cooking device 30b, and the processor 120 may determine a recipe by changing a recipe including the defrosting step without using the cooking device 30b (e.g., natural defrosting, thawing in running water, etc.) among the searched recipes to include the defrosting step using the cooking device 30b.

By determining the recipe to include the defrosting step that uses the cooking device 30b, the server 10 may increase cooking efficiency because the cooking object is thawed more quickly.

Furthermore, the server 10 may increase cooking convenience of the user by integrating the defrosting step and the cooking step into one recipe, as compared to an occasion when a defrosting recipe and a cooking recipe are provided separately.

Moreover, the processor 120 may transmit control information to the dish washer 30c to operate in a cleaning mode corresponding to the recipe performed, based on information about a mutual relation between the recipe and the cleaning mode when cooking is finished. In this case, the information about the mutual relation between the recipe and the cleaning mode may be created such that the cleaning mode matched has a higher cleaning intensity as the operation temperature required for the recipe increases.

In an embodiment, the memory 130 may store various information required for control. The memory 130 may receive information about the cooking object received from the refrigerator 30a or the user terminal 20. The information about the cooking object may be obtained by image processing on an image of the cooking object captured by the camera of the refrigerator 30a or the user terminal 20, or obtained by a user input through the refrigerator 30a or the user terminal 20.

The memory 130 may also store information about the cooking device 30b owned by the user. The information about the cooking device 30b may be received from the user terminal 20, and the user may update, through the user terminal 20, a list of the cooking devices 30b on hand.

Also, the memory 130 may store a plurality of recipes corresponding to a recipe name and store information about a cooking object and cooking device required per recipe and control information for the cooking device 30b for each recipe. Information about the recipes stored in the memory 130 may be updated by an external server.

Furthermore, the memory 130 may store information about a mutual relation between the recipe and the cleaning mode, which may be updated by the external server.

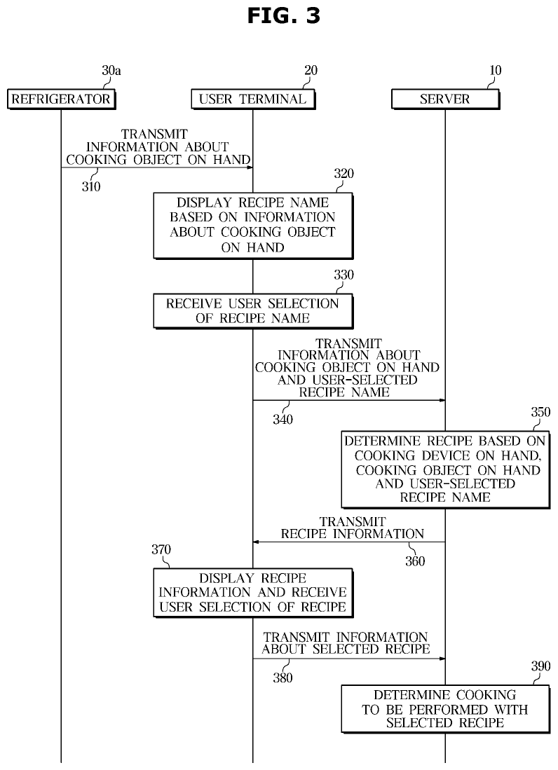

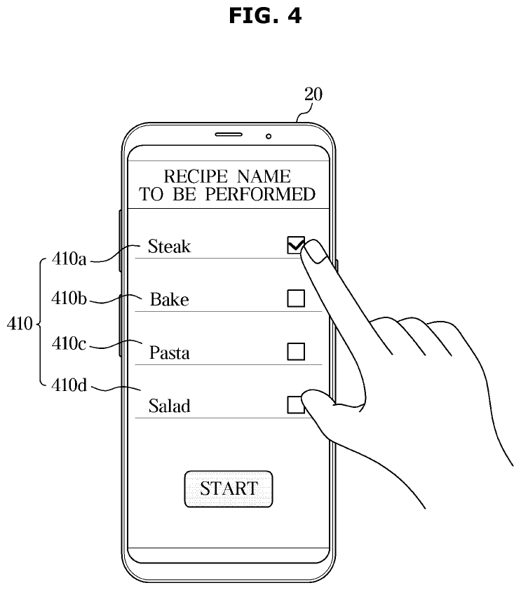

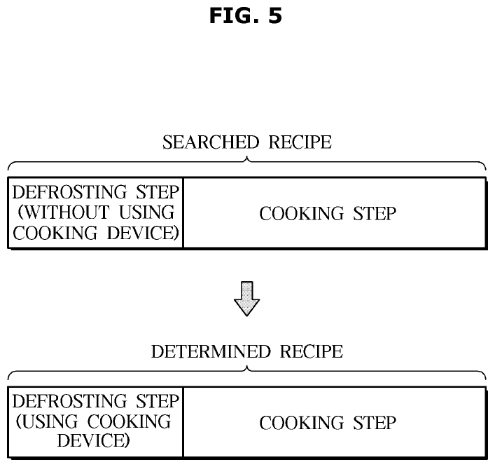

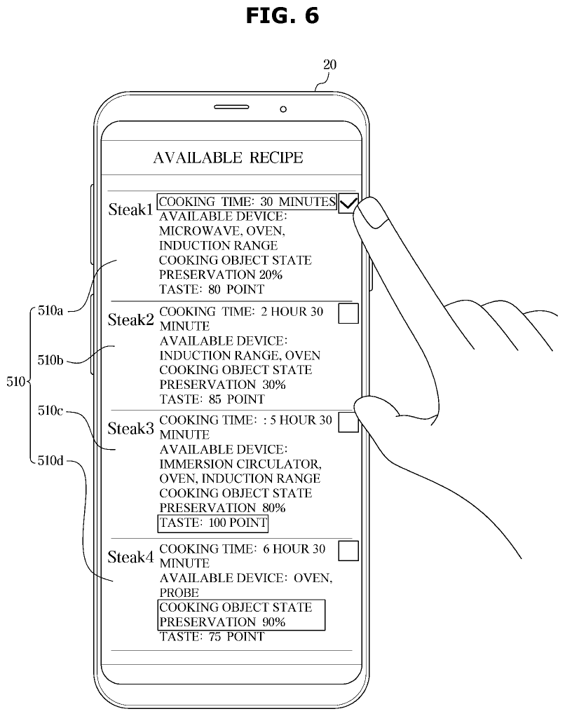

FIG. 3 is a signal sequence chart of the server 10 determining a recipe, according to an embodiment. FIG. 4 is a diagram illustrating an occasion when the user terminal 20 displays recipe names, according to an embodiment. FIG. 5 is diagram illustrating configuration of a recipe, according to an embodiment. FIG. 6 is a diagram for describing an occasion when the user terminal 20 displays recipes corresponding to a selected recipe name, according to an embodiment.

Referring to FIG. 3, the refrigerator 30a according to an embodiment may transmit information about cooking objects to the user terminal 20 in operation 310, and the user terminal 20 may display at least one recipe name based on the information about the cooking objects.

In operation 320, the user terminal 20 displays recipe name based on information about the cooking object.

As shown in FIG. 4, the user terminal 20 may display recipe names 410 corresponding to foods that may be cooked with the cooking objects on a user interface. For example, the user terminal 20 may display a steak recipe 410a, a baking recipe 410b, a pasta recipe 410c and a salad recipe 410d for the recipe name 410 to be cooked with the cooking objects.

In this case, the information about the cooking objects may be obtained based on a user input through the user terminal 20 or image processing on an image of the cooking object obtained through the camera of the user terminal 20 without being received from the refrigerator 30a.

The user terminal 20 may determine the recipe names 410 to be cooked with the cooking objects based on the information about the mutual relation between the recipe name and the cooking objects stored or received from the server 10 and the information about the cooking objects.

In an embodiment, the user terminal 20 may receive a user selection of one of the recipe names in operation 330, and transmit the information about the cooking objects and the user-selected recipe name to the server 10 in operation 340.

For example, as shown in FIG. 4, the user terminal 20 may receive a user input of selecting a steak recipe 410a for a recipe name, and transmit the steak recipe 410a to the server 10 as the user-selected recipe name.

In an embodiment, the server 10 may determine at least one recipe based on the cooking device 30b, the cooking objects and the user-selected recipe name in operation 350, and, in operation 360, transmit information about the at least one recipe to the user terminal 20.

The server 10 may determine the at least one recipe by searching for the recipes corresponding to the user-selected recipe name and available with the cooking device 30b on hand and the cooking objects.

In this case, the server 10 may determine the recipe such that the recipe includes a defrosting step and a cooking step. Specifically, the recipe may include a defrosting step for unfreezing the cooking object and a cooking step for cooking the cooking object by heating.

The defrosting step and the cooking step are performed by the cooking device 30b. As shown in FIG. 5, the server 10 may determine a recipe by changing a recipe (“SEARCHED RECIPE”) including the defrosting step without using the cooking device 30b (e.g., natural defrosting, thawing in running water, etc.) among the searched recipes to include the defrosting step using the cooking device 30b (“DETERMINED RECIPE”).

By determining the recipe to include the defrosting step that uses the cooking device 30b, the server 10 may increase cooking efficiency because the cooking object is thawed more quickly.

Furthermore, the server 10 may increase cooking convenience of the user by integrating the defrosting step and the cooking step into one recipe, as compared to an occasion when a defrosting recipe and a cooking recipe are provided separately.

In an embodiment, the user terminal 20 may display information about the at least one recipe received from the server 10 and receive a user selection for one of the recipes in operation 370.

As shown in FIG. 6, the user terminal 20 may display information about a recipe 510 on a user interface, and the information about the recipe 510 may include information about cooking time of the recipe, the cooking device 30b to be used, a cooking object state preservation, a taste score, etc.

In this case, in an embodiment of the disclosure, the recipe 510 transmitted from the server 10 and displayed on the user terminal 20 may comprises a plurality of cooking devices, and the server 10 may determine the plurality of recipes 510 focused on shortest cooking time, conditions of cooking objects and taste, respectively, and transmit the recipes 510 to the user terminal 20.

Specifically, the server 10 may determine a recipe with high operation temperature and short operation time of the cooking device 30b as the recipe focused on the shortest cooking time, and a recipe with low operation temperature and long operation time of the cooking device 30b as the recipe focused on the conditions of cooking objects. Furthermore, the server 10 may determine a recipe having a high frequency of use by the user or having a high user review score as the recipe focused on taste.

For example, as shown in FIG. 6, the user terminal 20 may display respective information of a plurality of recipes 510a to 510d: the first steak recipe 510a may correspond to the recipe focused on the shortest cooking time, the third steak recipe 510c may correspond to the recipe focused on taste, and the fourth steak recipe 510d may correspond to the recipe focused on conditions of cooking objects.

In an embodiment, the user terminal 20 may transmit information about a recipe selected by the user to the server 10 in operation 380, and the server 10 may determine to perform cooking with the selected recipe in operation 390.

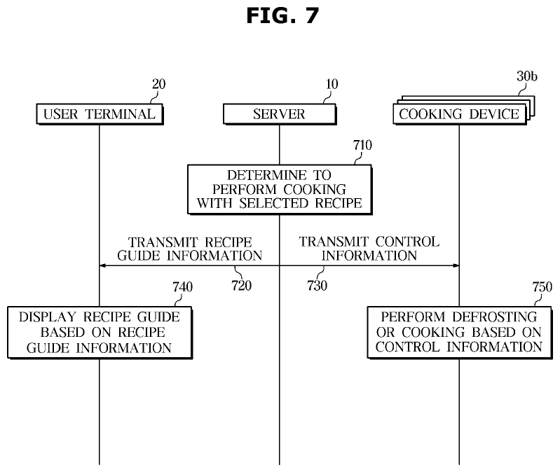

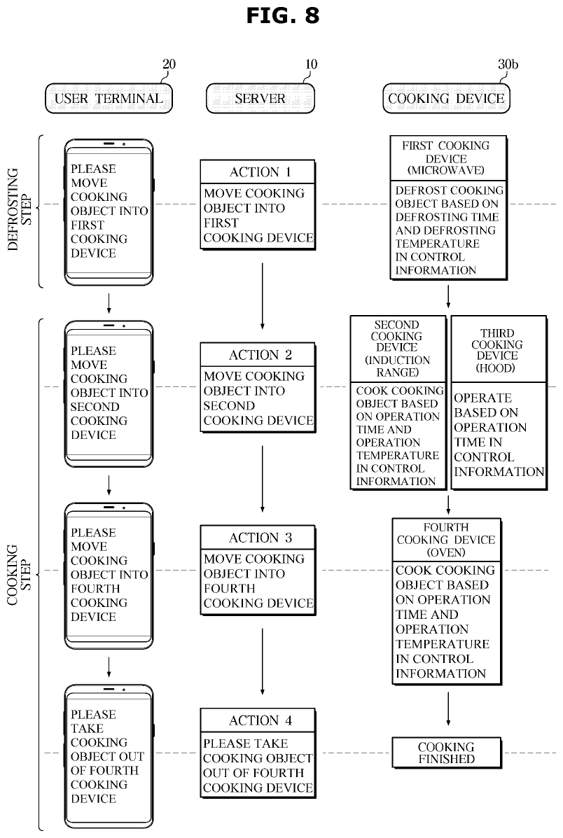

FIG. 7 is a signal sequence chart of the server 10 that performs cooking with a selected recipe, according to an embodiment, and FIG. 8 is a diagram illustrating operations of the cooking device 30b and corresponding user actions, according to an embodiment.

Referring to FIG. 7, the server 10 according to an embodiment may determine, in response to receiving a selection of a recipe from the user terminal 20, cooking to be performed with the selected recipe in operation 710, transmit recipe guide information corresponding to the selected recipe to the user terminal 20 in operation 720, and transmit control information corresponding to the selected recipe to the cooking device 30b in operation 730.

The recipe guide information may include information about a user action, which indicates the user action for cooking.

The control information may include at least one of information about operation time of the cooking device 30b or information about operation temperature of the cooking device 30b.

In this case, the server 10 may transmit control information stored to correspond to the recipe to the cooking device 30b, or transmit, to the cooking device 30b, control information updated by changing at least one of the operation time information or the operation temperature information based on information about the cooking object.

In other words, the server 10 may update the control information by controlling the operation time or the operation temperature based on weight or quantity of the cooking object.

For example, the server 10 may determine the control information for the cooking device 30b to perform the defrosting step by determining defrosting time and defrosting temperature based on the information about the cooking object. In other words, the server 10 may determine the control information by increasing the operation time or operation temperature with an increase in weight or quantity of the cooking object.

In an embodiment, upon reception of recipe guide information from the server 10, the user terminal 20 may display a recipe guide based on the recipe guide information, in operation 740.

In other words, the user terminal 20 may display a message inducing a user action on the user interface to guide to a recipe based on the recipe guide information.

In an embodiment, on receiving control information from the server 10, the cooking device 30b may perform defrosting or cooking based on the control information in operation 750.

Specifically, the cooking device 30b may control the thermal source to emit heat at an operation temperature for an operation time based on the operation time information and the operation temperature information included in the control information, when the cooking object is placed in the cooking device 30b according to a user action.

Furthermore, the cooking device 30b may comprise a plurality of cooking devices in an embodiment, and the server 10 may transmit the control information to the respective cooking devices 30b, and the recipe guide information may include information about operation order between the plurality of cooking devices 30b.

In this case, the server 10 may determine the cooking device 30b to perform the defrosting step in the recipe among the plurality of cooking devices 30b based on at least one of the type of the recipe or the type of cooking object.

For example, the server 10 may determine the cooking device 30b having high thermal output power as the cooking device 30b to perform the defrosting step for the recipe focused on the shortest cooking time, and may determine the cooking device 30b having low thermal output power as the cooking device 30b to perform the defrosting step for the recipe focused on the condition of the cooking object. Furthermore, the server 10 may determine the cooking device 30b corresponding to the type of the cooking object as the cooking device 30b to perform the defrosting step based on information about a mutual relation between the type of the cooking object and the optimal cooking device 30b.

As such, when the user owns the plurality of cooking devices 30b, the server 10 may induce a user action to sequentially place the cooking object into the plurality of cooking devices 30b by making the user terminal 20 to show an operation sequence between the plurality of cooking devices 30b, and operate the plurality of cooking devices 30b in sequence for the cooking object to be sequentially cooked by the plurality of cooking devices 30b.

For example, as shown in FIG. 8, the user terminal 20 may sequentially guide user actions required for cooking when receiving recipe guide information from the server 10. In the illustration of FIG. 8, the recipe to be performed is a recipe by which the cooking object is cooked by being moved on to the first cooking device, the second cooking device and the fourth cooking device in sequence.

On receiving the recipe guide information from the server 10, the user terminal 20 may display a message for inducing a user action to move the cooking object into the first cooking device.

Specifically, the user terminal 20 may identify the first cooking device (e.g., a microwave) corresponding to the first operation order based on the information about operation order between the plurality of cooking devices 30b, and display a message to induce the user action of moving the cooking object into the first cooking device based on information about the user action. In this case, the first cooking device may correspond to a cooking device that performs the defrosting step corresponding to a preceding step between the defrosting step and the cooking step.

The user may check the message on the user terminal 20 and perform the user action (action 1) to move the cooking object into the first cooking device. In this case, the first cooking device may control the thermal source to defrost the cooking object based on defrosting time and defrosting temperature in the control information.

In an embodiment, the user terminal 20 may display a message for inducing a user action to move the cooking object into the second cooking device (e.g., an induction range) corresponding to a subsequent operation order after the lapse of the defrosting time. The user may check the message on the user terminal 20 and perform the user action (action 2) to move the cooking object into the second cooking device. In this case, the second cooking device may control the thermal source to cook the cooking object based on operation time and operation temperature in the control information. Simultaneously, the third cooking device (e.g., a range hood) may control a suction fan to suck in air containing odor and smoke based on the operation time in the control information.

In an embodiment, the user terminal 20 may display a message for inducing a user action to move the cooking object into the fourth cooking device (e.g., an oven) corresponding to a subsequent operation order after the lapse of the operation time of the second cooking device. The user may check the message on the user terminal 20 and perform the user action (action 3) to move the cooking object into the fourth cooking device. In this case, the fourth cooking device may control the thermal source to cook the cooking object based on operation time and operation temperature in the control information.

In an embodiment, the user terminal 20 may display a message for inducing a user action to take the cooking object out of the fourth cooking device (e.g., the oven) after the lapse of the operation time of the fourth cooking device. The user may check the message on the user terminal 20 and perform the user action (action 4) to take the cooking object out of the fourth cooking device, and accordingly, cooking of the cooking object may be finished.

As such, the server 10 may induce a user action corresponding to a recipe to be performed by transmitting recipe guide information corresponding to the recipe to the user terminal, and provide a food corresponding to the recipe to the user by transmitting control information corresponding to the recipe to the cooking device to cook the cooking object.

In this case, the server 10 may provide a defrosting step for defrosting cooking object and a cooking step for cooking the cooking object by heating in one recipe for the user to select the recipe for cooking more conveniently, and arrange both the defrosting step and the cooking step to use the cooking device 30b, thereby increasing cooking efficiency.

An embodiment of a method of controlling the server 10 will now be described. As for the method, the server 10 in the aforementioned embodiment may be used. Hence, what are described above with reference to FIGS. 1 to 8 may be equally applied in the following method of controlling the server 10.

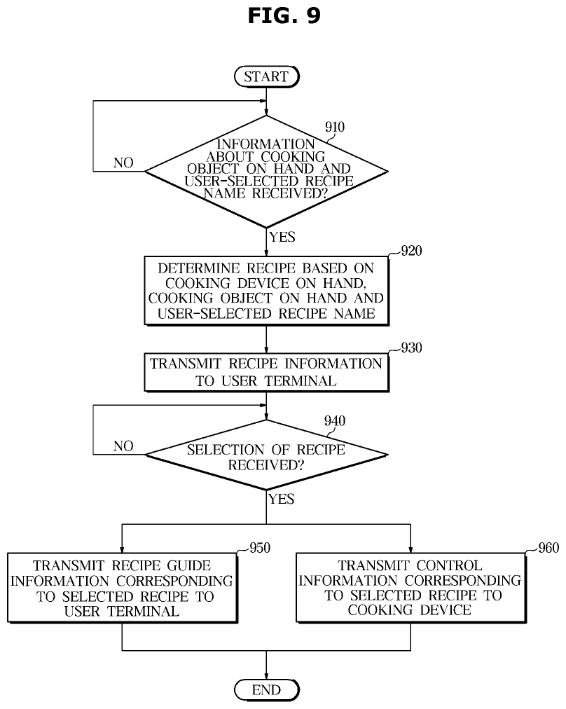

FIG. 9 is a flowchart of controlling the cooking device 30b in a method of controlling the server 10, according to an embodiment.

Referring to FIG. 9, on receiving information about a cooking object and a user-selected recipe name in operation 910, the server 10 may determine at least one recipe based on the cooking device 30b on hand, the cooking object and the user-selected recipe name in operation 920.

The server 10 may determine at least one recipe by searching for the recipes corresponding to the user-selected recipe name and available with the cooking device 30b on hand and the cooking object.

In this case, the server 10 may determine the recipe such that the recipe includes a defrosting step and a cooking step which use the cooking device 30b. Specifically, the recipe may include a defrosting step for unfreezing the cooking object and a cooking step for cooking the cooking object by heating.

By determining the recipe to include the defrosting step that uses the cooking device 30b, the server 10 may increase cooking efficiency because the cooking object is thawed more quickly.

Furthermore, the server 10 may increase cooking convenience of the user by integrating the defrosting step and the cooking step into one recipe, as compared to an occasion when a defrosting recipe and a cooking recipe are provided separately.

In an embodiment, the server 10 may transmit information about the determined recipe to the user terminal 20 in operation 930, on receiving a user selection of at least one recipe from the user terminal 20 in operation 940, transmit recipe guide information corresponding to the recipe to the user terminal 20 in operation 950, and transmit control information corresponding to the selected recipe to the cooking device 30b in operation 960.

The recipe guide information may include information about a user action, which indicates the user action for cooking.

The control information may include at least one of information about operation time of the cooking device 30b or information about operation temperature of the cooking device 30b.

In an embodiment, upon reception of the recipe guide information from the server 10, the user terminal 20 may display a recipe guide based on the recipe guide information.

In other words, the user terminal 20 may display a message inducing a user action on the user interface to guide to a recipe based on the recipe guide information.

In an embodiment, on receiving the control information from the server 10, the cooking device 30b may perform defrosting or cooking based on the control information.

Specifically, the cooking device 30b may control the thermal source to emit heat at an operation temperature for an operation time based on the operation time information and the operation temperature information included in the control information, when the cooking object are placed in the cooking device 30b according to a user action.

As such, the server 10 may induce a user action corresponding to a recipe to be performed by transmitting recipe guide information corresponding to the recipe to the user terminal, and provide a food corresponding to the recipe to the user by transmitting control information corresponding to the recipe to the cooking device to cook the cooking object.

In this case, the server 10 may provide a defrosting step for defrosting cooking object and a cooking step for cooking the cooking object by heating in one recipe for the user to select the recipe for cooking more conveniently, and arrange both the defrosting step and the cooking step to use the cooking device 30b, thereby increasing cooking efficiency.

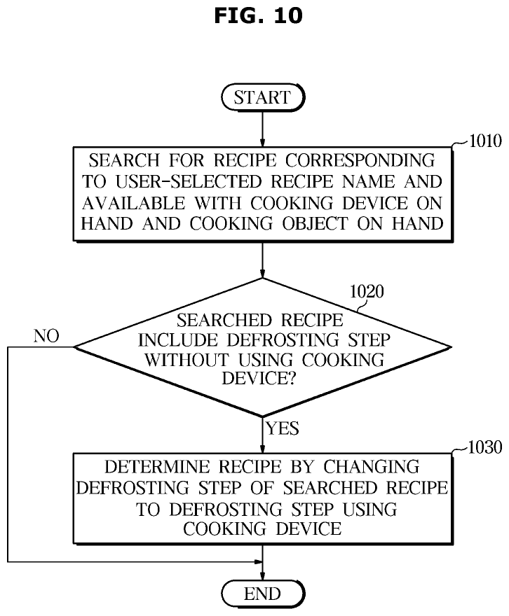

FIG. 10 is a flowchart of determining a recipe including a defrosting step using a cooking device in a method of controlling the server 10, according to an embodiment.

Referring to FIG. 10, the server 10 may search for a recipe corresponding to a user-selected recipe name and available with the cooking device 30b on hand and cooking object in operation 1010, and when the searched recipe includes a defrosting step that does not use the cooking device 30b in operation 1020, determine a recipe by changing the defrosting step of the searched recipe to use the cooking device 30b in operation 1030.

The server 10 may determine at least one recipe by searching for the recipes corresponding to the user-selected recipe name and available with the cooking device 30b on hand and the cooking object.

In this case, the server 10 may determine the recipe such that the recipe includes a defrosting step and a cooking step. Specifically, the recipe may include a defrosting step for unfreezing the cooking object and a cooking step for cooking the cooking object by heating.

The defrosting step and the cooking step are performed by the cooking device 30b, and the server 10 may determine a recipe by changing a recipe including the defrosting step without using the cooking device 30b (e.g., natural defrosting, thawing in running water, etc.) among the searched recipes to include the defrosting step using the cooking device 30b.

By determining the recipe to include the defrosting step that uses the cooking device 30b, the server 10 may increase cooking efficiency because the cooking object is thawed more quickly.

The embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

What is claimed is:

1. A server comprising:
a transceiver configured to perform communication with a user terminal and a cooking device; and
a processor operatively connected to the transceiver,
wherein the processor is configured to, based on receiving a selection of a recipe from the user terminal, control the transceiver to transmit, to the user terminal, recipe guide information corresponding to the recipe, and transmit, to the cooking device, control information corresponding to the recipe,
wherein the recipe comprises a defrosting step and a cooking step, which use the cooking device.

2. The server of claim 1, wherein the processor is further configured to:
determine at least one recipe based on the cooking device, a cooking object that is available, and a user-selected recipe name, and
control the transceiver to transmit information about the at least one recipe to the user terminal.

3. The server of claim 2, wherein the processor is further configured to:
search for a recipe corresponding to the user-selected recipe name and available with the cooking device and the cooking object, and
based on the searched recipe comprising a defrosting step without using the cooking device, determine a recipe by changing the defrosting step of the searched recipe to a defrosting step using the cooking device.

4. The server of claim 2, wherein the processor is further configured to determine the control information for the cooking device by determining a defrosting time and a defrosting temperature based on information about the cooking object.

5. The server of claim 2, wherein the at least one recipe comprises at least one of a recipe with a shortest cooking time, a recipe focused on taste, or a recipe focused on a condition of the cooking object.

6. The server of claim 5, wherein the cooking device comprises a plurality of cooking devices, and
wherein the processor is further configured to control the transceiver to transmit the control information to at least one of the plurality of cooking devices.

7. The server of claim 6, wherein the processor is further configured to, based on at least one of a type of the recipe or a type of the cooking object on hand, determine a cooking device to perform the defrosting step of the recipe among the plurality of cooking devices.

8. The server of claim 6, wherein the recipe guide information comprises information about an operation order between the plurality of cooking devices and information about a user action.

9. The server of claim 1, wherein the control information comprises at least one of information about an operation time of the cooking device or information about an operation temperature of the cooking device.

10. The server of claim 1, wherein the processor is further configured to control the transceiver to transmit, to a dish washer, a washing mode based on the selected recipe.

11. A method of controlling a server comprising a transceiver for performing communication with a user terminal and a cooking device, the method comprising:
based on receiving a selection of a recipe from the user terminal, controlling the transceiver to transmit, to the user terminal, recipe guide information corresponding to the recipe; and
controlling the transceiver to transmit control information corresponding to the recipe to the cooking device,
wherein the recipe comprises a defrosting step and a cooking step, which use the cooking device.

12. The method of claim 11, further comprising:
determining at least one recipe based on the cooking device, a cooking object that is available, and a user-selected recipe name; and
controlling the transceiver to transmit information about the at least one recipe to the user terminal.

13. The method of claim 12, wherein the determining the at least one recipe comprises:
searching for a recipe corresponding to the user-selected recipe name and available with the cooking device and the cooking object; and
based on the searched recipe comprising a defrosting step without using the cooking device, determining the at least one recipe by changing the defrosting step of the searched recipe to a defrosting step using the cooking device.

14. The method of claim 12, further comprising:
determining the control information for the cooking device by determining a defrosting time and a defrosting temperature based on information about the cooking object.

15. The method of claim 12, wherein the at least one recipe comprises at least one of a recipe with a shortest cooking time, a recipe focused on taste, or a recipe focused on a condition of the cooking object.
